(19) United States
(12) Patent Application Publication
(10) Pub. No.: US 2004/0131335 A1
(43) Pub. Date: Jul. 8, 2004

(54) Method and apparatus for providing anytime television interactivity

(76) Inventors: Joseph F. Halgas JR., Huntingdon Valley, PA (US); Christopher J. Stone, Newtown, PA (US); John Kamieniecki, Lafayette Hill, PA (US)

Correspondence Address: STEVEN L. NICHOLS, RADER, FISHMAN & GRAVER PLLC, 10653 S. RIVER FRONT PARKWAY, SUITE 150, SOUTH JORDAN, UT, 84095, US

(21) Appl. No.: 10/336,450

(22) Filed: Jan. 2, 2003

(51) Int. Cl. H04N 5/76; G06F 3/00; G06F 13/00

(52) U.S. Cl. 386/83; 725/58

(57) ABSTRACT

A method for recording a television program with interactive content includes recording data supporting interactive features of the television program in addition to recording the television program.

### FIELD

The present invention relates to interactive television programming. More particularly the present invention provides a system for recording and later replaying an interactive television program.

### BACKGROUND

More and more often, television (TV) programs are being designed to be interactive, meaning that the viewer has some interaction with the programming beyond passively watching the programming as has been traditional. With the right equipment, an interactive television system is capable of registering and, perhaps, responding to viewer actions or responses to a television program. These interactive television programs allow a user to actively participate with the TV program by, for example, answering questions, asking questions, obtaining more information about the program or its content, and/or providing feedback during the interactive program. Interactive television systems typically display text and graphic images as part of the viewer interaction in addition to displaying the traditional video program streams.

Interactive television provides a variety of marketing, entertainment, and educational capabilities. For example, a user may interact with televised programs by ordering advertised products or services, competing against contestants in a game show, or requesting specialized information regarding particular programs. Many users are attracted to enhanced TV programs because of the challenge and manner in which they are able to participate and receive feedback.

Presently, most interactive television systems include a set-top box connected to the user's television. A set-top box is a box of electronics that is typically used to interface a viewer's television set with a cable or satellite television system.

Set-top boxes commonly include, or are connected to, a personal video recorder (PVR) capable of recording and then replaying television (TV) programs. A PVR is defined herein and in the appended claims as a video recorder containing a digital data storage device such as a hard drive, a re-writeable digital video disk (DVD), or other memory systems capable of storing significant amounts of digital data. A videocassette recorder (VCR) may also be considered a form of PVR for purposes of this specification.

Many viewers will record programs if they are unable to watch those programs during the appointed broadcast time. However, if the recorded program is an interactive program, the enhanced interactive features are lost. Consequently, when a user watches the recorded program, the program is no longer interactive.

Additionally, the advent of PVR devices has made it easier for a user to record a television program and subsequently watch the program without viewing the periodic commercials. The user is able to skip or ‘fast-forward’ through the commercials. The ability to avoid commercials while viewing a program is problematic to content providers who depend on the revenue generated from advertisers who pay to have viewers see their commercials.

### SUMMARY

In one of many possible embodiments, the present invention provides a method for recording a television program with interactive content by recording data supporting interactive features of the television program in addition to recording the television program.

### BRIEF DESCRIPTION OF THE DRAWINGS

The accompanying drawings illustrate various embodiments of the present invention and are a part of the specification. The illustrated embodiments are merely examples of the present invention and do not limit the scope of the invention.

FIG. 1 illustrates an embodiment of an interactive set-top system for the recording of an interactive TV program according to one embodiment of the present invention.

FIG. 2 illustrates an interactive set-top recorder and playback system according to one embodiment of the present invention.

FIG. 3 is a process diagram illustrating a method of operating the interactive set-top recorder and playback system of FIG. 2 in accordance with one embodiment of the present invention.

FIG. 4 illustrates an interactive set-top recorder and playback system according to an alternative embodiment of the present invention.

FIG. 5 is a process diagram illustrating a method of operating the interactive set-top recorder and playback system of FIG. 4 in accordance with one embodiment of the present invention.

FIG. 6 illustrates an interactive set-top recorder and playback system according to yet another embodiment of the present invention.

FIG. 7 is a flowchart illustrating a method of operating the system illustrated in FIG. 6 in accordance with one embodiment of the present invention.

Throughout the drawings, identical reference numbers designate similar, but not necessarily identical, elements.

### DETAILED DESCRIPTION OF THE ILLUSTRATED EMBODIMENTS

A method and apparatus described herein provide interactive features to a previously recorded television program. In the following description, for purposes of explanation, numerous specific details are set forth in order to provide a thorough understanding of the invention. It will be apparent, however, to one skilled in the art that the invention can be practiced without these specific details.

Reference in the specification to “one embodiment” or “an embodiment” means that a particular feature, structure, or characteristic described in connection with the embodiment is included in at least one embodiment of the invention. The appearance of the phrase “in one embodiment” in various places of the specification are not necessarily all referring to the same embodiment.

Exemplary Overall Structure

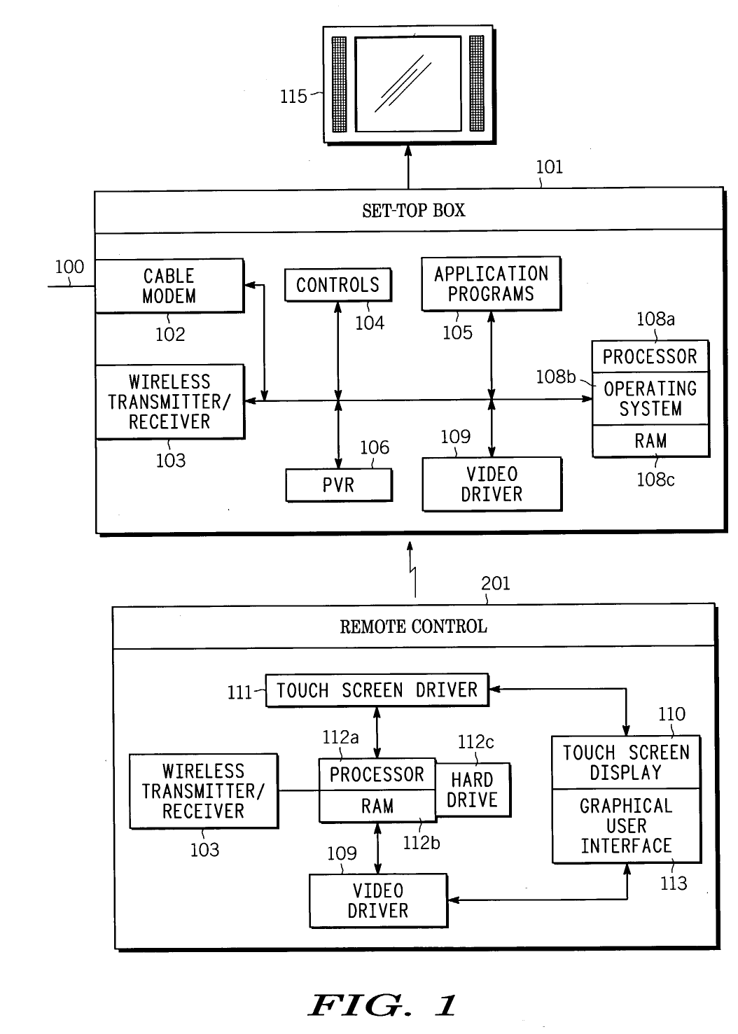

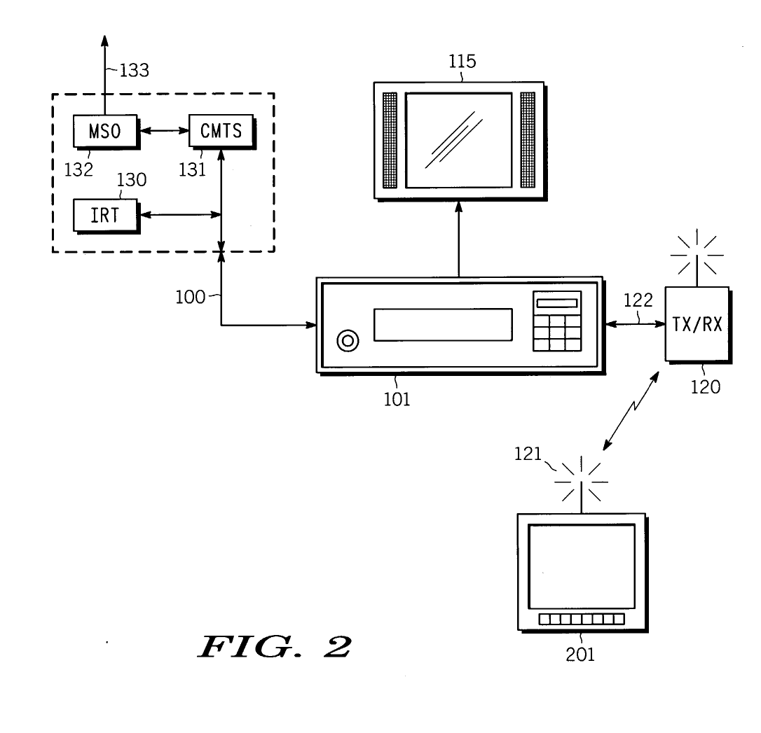

FIGS. 1 and 2 illustrate one embodiment of an interactive set-top system for playing back previously-recorded interactive programs, while maintaining the interactive features of the recorded program. As illustrated in FIG. 1, the interactive playback system preferably includes a television display (115) that is communicatively connected to an interactive set-top box (101) (hereafter referred to as an interactive set-top).

A wireless webpad or other remote control unit (201) is placed in communication with the interactive set-top (101) to provide enhanced user control and interaction with the system. The webpad will be described in greater detail below.

The set-top (101) is also connected to a source of a television signal, such a cable television system cable television connection (100). It is also possible to utilize a satellite television connection or any other means capable of transmitting an interactive TV program in place of, or in combination with the cable television connection (100).

The TV display (115) illustrated in FIG. 1 is preferably a standard television used to display information received from the interactive set-top (101). A cathode ray tube, flat panel, plasma screen, monitor, projector, or other display device may be used in the place of the TV display (115). The interactive set-top (101) is preferably connected to the TV display (115) through traditional connection means including, but in no way limited to RCA, optical, and/or S-video connections. It is also possible for the interactive set-top (101) to be integrated with the TV display (115) to form a single functional unit.

The TV display (115) illustrated in FIG. 1 is connected to an interactive set-top (101). The interactive set-top (101) preferably contains an internal cable modem (102) that allows the interactive set-top (101) to send and receive information over the Internet or other network using a cable TV (CATV) connection (100), which may have a specified bandwidth for Internet connectivity. Generally, a CATV connection (100) used in conjunction with a cable modem (102) allows data packets as well as a standard CATV signal to be transferred over a standard coaxial CATV connection at a rate much higher than a standard telephone dial-up connection. The cable modem (102) of the interactive set-top (101) is able to control the transmission properties of both data transmitted and data received. Alternatively, the cable modem (102) may be an external and separate component that is networked to the interactive set-top (101) by an Ethernet or other connection. Additionally, it is possible to use a two-way radio frequency modem, a two-way telephone modem, a Data Over Cable Service Interface Specifications (DOCSIS) cable modem, or any other means of two-way communication capable of sending and receiving information in place of, or in connection with the cable modem (102). A connection to the Internet is important because the Internet can be used to provide interactive features in conjunction with a television program.

The cable modem (102) of the interactive set-top (101) may pass a broadcast audio-video interactive signal to a processor (108a). The processor (108a) of the interactive set-top (101) is capable of demultiplexing the packets from the broadcast signal if necessary and reconstructing the television programs and/or interactive applications embodied in the signal. The programs and applications are then decompressed by decompression software that is one of various application programs (105) stored on the set-top (101). The processor (108a) of the interactive set-top will likely have access to random access memory (RAM) (108c). Additionally, an operating system may be stored in the RAM (108c) for coordinating the software tasks that are sent to the processor (108a). Additional tuning equipment or programs may also be used in conjunction with the cable modem (102).

A server (not shown) is usually provided to support the interactive features of the interactive TV programming. The server may provide questions regarding the programming to which the user can respond or may receive user responses to questions asked in the TV programming. The server may also provide additional information related to the interactive programming that a user can selectively access, including advertising. Additionally, the server may take orders for products advertised and sold through the interactive programming.

The server supporting the interactive TV programming may be located on the Internet or some other network. The interactive set-top (101) is connected to the Internet or other network so as to be in communication with the server supporting the TV programming. By communicating with the server, the interactive set-top (101) then enables the interactive features of the TV programming.

The interactive set-top (101) may also include an internal wireless transmitter/receiver (103). The wireless transmitter/receiver (103) allows information to be passed wirelessly between the webpad or other remote control unit (201) and the interactive set-top (101). The wireless transmitter/receiver (103) may also be a separate component connected to the interactive set-top (101) by a serial connection.

The webpad (201) is a remote control unit that preferably includes a display device and user input device, such as a keypad. In some embodiments, the webpad may include a touch-screen that serves as both a display device and a user input device. With the webpad (201), the user can receive, view, and respond to data transmitted from the interactive set-top (101), this may include information from the Internet or World Wide Web which the interactive set-top (101) has obtained using the cable modem (102) or like component.

The wireless communication between the wireless transmitter/receiver (103) of the interactive set-top (101) and the webpad (201) of FIG. 1 may use the principles and technology of a wireless local area network (WLAN) or may be carried on an existing WLAN. A WLAN is a network in which a mobile or roving device can connect to other devices through a local area network (LAN) that includes one or more wireless radio frequency (RF) connections for communicating with the mobile device. It is also possible that the cable modem (102) illustrated as an internal component of the interactive set-top have access to the WLAN for direct communication with the webpad (201), the Internet, or other devices.

The wireless communication used by the webpad (201) and/or the interactive set-top (101) preferably functions according to the original Institute of Electrical and Electronics Engineers wireless-Ethernet specification or standard, known as IEEE 802.11, which standard is hereby incorporated by reference. IEEE 802.11 designates two ways of communicating between devices: direct-sequence spread spectrum (DSSS) and frequency-hopping spread spectrum (FHSS). These communications methods allow for speeds of up to 2 Mbps using frequency-shift keying (FSK). HomeRF, including shared wireless access protocol (SWAP) is also a wireless standard that may be used. Moreover, the wireless communication used in this and other embodiments may employ standards and techniques that are still being developed such as IEEE standard 802.15 and Bluetooth technology. The wireless communication described herein may employ any of the aforementioned standards of wireless communication or combinations thereof and will simply be referred to hereafter as a wireless connection or a wireless signal.

The interactive set-top (101) may also include a personal video recorder (PVR) (106). The PVR (106) allows content received from the cable connection (100) to be recorded and stored for viewing at a later time. The PVR (106) also allows both an interactive TV program and corresponding interactive content to be recorded simultaneously. As with various other components, the PVR may be external to the interactive set-top (101) with a simple serial or other connection allowing a user to integrate a previously acquired device.

As indicated above, a PVR (e.g., 106) may also include a rewriteable DVD. When a DVD is employed as a data storage device in the PVR (106), the interactive set-top may command the DVD to create specific menu entries, i.e. bookmarks to certain points in the broadcast, questions, etc. This enables the PVR (106) to create a customized interactive DVD that the user may keep and playback at any time, including the interactive content of the program. This will be explained in more detail below.

A user input device may also be included in the set-top (101), including, for example, various buttons, knobs, and other devices for programming and controlling the recording and play back information on the interactive set-top (101). However, the primary means of controlling the set-top (101) is preferably the webpad or other remote control unit (201). The controlling elements that can be used with or without the use of the remote webpad (201) will be referred to hereafter as controls (104). The controls (104) allow the user to program the interactive set-top (101) for various functions. The controls (104) of the interactive set-top (101) may allow the user to program such things as desired television channel, beginning recording time, recording duration, and/or any other information the user deems useful.

FIG. 1 also illustrates the basic internal components of a webpad (201). As indicated above, the webpad (201) is a remote control device for controlling the elements of an interactive TV system as previously described. Preferably, the webpad (201) has a wireless transmitter/receiver (103) for both sending and receiving wireless signals. The webpad (201) also includes a processor (112a) for processing signals and running software or firmware applications. The processor (112a) is the central processing unit (CPU) within the webpad (201) and has access to random access memory (RAM) (112b). It is also possible that the CPU accesses other dynamically accessible memory structures including but not limited to flash memory structures.

Additionally, an operating system may be stored in the RAM (112b) for coordinating the software tasks that are sent to the processor (112a). The processor (112a) and operating system (not shown) coordinate the computing elements of the webpad (201) by allocating memory space and time for each process as well as processing application programs.

A hard drive (112c) or other nonvolatile memory is connected to the processor (112a) and RAM (112b) of the webpad (201). The hard drive (112c) allows large amount of interactive data to be downloaded to the webpad (201) through the wireless transmitter/receiver and processed before being stored locally on the hard drive (112c).

The webpad (201) also includes a user interface (e.g., 110) that allows a user to interact with the components of the webpad (201). The user interface preferably includes a display (110) that can be used for displaying enhanced portions or interactive elements of an interactive TV program and for allowing the user to control the webpad (201). As used herein, the display (110) may be a touch screen, a liquid crystal display (LCD), light emitting diode (LED), cathode ray tube (CRT), or any other display element that allows an incoming or outgoing signal to be visually displayed. The display is preferably a touch screen display (110) due to the inherent input and output functionality of touch screen displays. A touch screen display (110) allows data to be displayed and facilitates user interaction with the webpad (201). Alternatively, the controlling elements of the touch screen display (110) described above may include a mouse, trackball, Braille keypad, light pen, or any other mechanism that allows the user to input information or otherwise control the webpad (201).

A graphical user interface (GUI) (113) may also be included in the webpad (201) and works in conjunction with the touch screen display (110). A GUI (113) (rather than a purely textual interface) allows a user to interactively interface with the webpad (201) using the touch screen display (110) and may be part of the operating system. A GUI (113) may display graphical elements such as: windows, pull-down menus, buttons, scroll bars, iconic images, wizards, etc. As each of the above-mentioned GUI elements is touched on the touch screen display (110), they are converted to an action or character to be used by the computing functionality of the webpad (201). Thus, the GUI (113) allows the user to view or enter information.

In some embodiments, the GUI (113) may be able to display an alphanumeric keyboard on the touch screen display (110). The alphanumeric keyboard displayed by the GUI (113) may function as a normal keyboard in allowing a user to enter text characters or numbers used in inputting feedback to an interactive program.

The webpad (201) of FIG. 1 may also include a number of drivers (109, 111). A driver is a program that interacts with a specific device or software application program. The driver contains the special knowledge of the device or software interface to allow communication between the device or software interface and a controlling processor or program.

As noted above, the interactive system of FIG. 1 also includes an Internet or other network connection. As illustrated in FIG. 1, the CATV connection (100) may also serve as an Internet connection. The Internet connection (100) of FIG. 1 may be any one of a CATV, fiber optic, Ethernet, DSL, phone-line, satellite, or any other connection that allows the transfer of digital data. The Internet connection is preferably a cable CATV connection (100) to simplify the use with the interactive set-top. The CATV connection (100) allows the interactive set-top (101) and the webpad (201) to display, transfer, and search available information from the Internet.

FIG. 2 is an illustration of one embodiment of an interactive playback system further illustrating the CATV connection (100). As illustrated in FIG. 2, the CATV connection (100) may be connected to various devices. In one embodiment, the cable connection may connect with an integrated receiver transcoder (IRT), out-of-band modulator (OM), return path demodulator (RPD), or other similar cable transmission equipment. Each of the proceeding devices will be referred to as the IRT (130). In one embodiment, the IRT (130) represents those components necessary to produce and transmit a standard CATV signal to a receiving set-top.

The CATV connection (100) may also be connected to a cable modem termination system (CMTS) (131). The CMTS (131) is a component that exchanges digital signals with the cable modems of a cable network. The CMTS (131) interfaces with a multiple cable system operator (132) (MSO) that is preferably both an Internet service provider (ISP) and a CATV provider. In this manner the MSO (132) may provide both a cable television program as well as the corresponding interactive content that is, in most cases, provided using an Internet connection. Additionally, the MSO (132) may connect to the rest of the Internet (133) including additional servers and routers through any number of possible connections including wireless, fiber-optic, copper, etc. The Internet connection (133) access through the MSO (132) allows the user to view available information, access websites, and download the interactive data necessary to participate in some interactive television programs.

FIG. 2 also illustrates that the webpad (201) may communicate with the interactive set-top (101) by transmitting wireless signals through a wireless antenna (121) located on the webpad (201). The interactive set-top (101) of FIG. 2 may be have an internal wireless transceiver, as in the embodiment of FIG. 1, or may be connected to an external wireless transmitter/receiver (120) through a serial cable (122) or other connection. The external wireless transmitter/receiver (120) functions in the same manner as the integrated transmitter/receiver (103) previously described in FIG. 1.

Exemplary Implementation and Operation

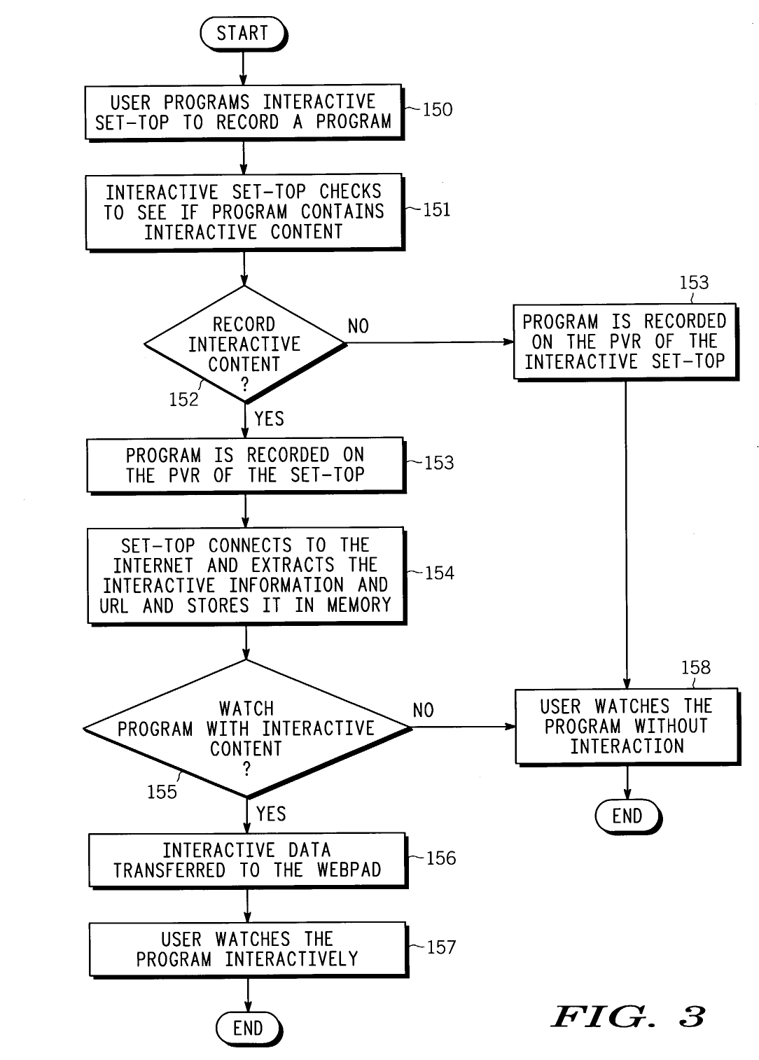

FIG. 3 is a flowchart illustrating a preferred method of operating the interactive set-top system of FIGS. 1 and 2 according to one embodiment of the present invention. The operation of the interactive playback system begins as a user programs the interactive set-top (101, FIG. 2) to record a specific program (Step 150) for possible future viewing. The programming is performed using the controls (104, FIG. 1) of the interactive set-top or the webpad (201, FIG. 1). The user may choose both the program as well as the duration of time to record. The user may also be able to record multiple programs simultaneously.

Once the user has selected the program to record, the interactive set-top checks to see if the program contains interactive content (Step 151). The interactive set-top may check for interactive content by accessing a list of interactive programs. This list may be provided directly by a television service provider over the connection to the set-top (100, FIG. 2) or on the Internet. If the program selected by the user is included on the list of interactive programs provided by the Internet, the user is provided with the option of recording the interactive content (Step 152) along with the program video.

If the user chooses not to record the interactive content, or if the television program does not contain interactive content, the program content is recorded on the PVR (106, FIG. 1) of the interactive set-top (Step 153) without any consideration for corresponding interactive content. The program is recorded as the program signal is transmitted from the IRT (130; FIG. 2) to the interactive set-top (101; FIG. 2). The user may then view the recorded program at any time (Step 158). If the program contained interactive features, those features will likely be absent from the recorded version of the program.

However, if the television program does contain interactive content and the user selects to record the program and its interactive content (Step 152), both the program and the interactive content are recorded on the PVR of the set-top (Step 153). In order to record interactive content that is provided in conjunction with the Internet, the interactive set-top connects to the website corresponding to the selected TV program through the Internet connection (100, FIG. 2) and extracts and stores in local memory the interactive information. This may include a Uniform Resource Locator (URL) corresponding to the interactive program. The URL contains the name of the protocol required to access the resource, a domain name that identifies a specific computer on the Internet, and a hierarchical description of a file location on the computer. The interactive content received from the Internet is preferably linked with a portion of the television broadcast in a sequential order to facilitate the reconstruction and interactive play back of the television program and its interactive content. The interactive content as well as the necessary URL associated with the interactive content are commonly stored on the local memory of the set-top (101, FIG. 2).

Alternatively, the interactive features of the television program may be embedded in the signal for the television program. In this case, the interactive data can be extracted by the set-top (101, FIG. 2), as it would be if the program were being watched instead of recorded. The interactive features, information, applets, etc. are stored by the PVR for use during replay of the recorded program.

Once both the program content and the interactive information have been locally stored in the interactive set-top, the program is available for interactive viewing by the user. When the user accesses the program through the interactive set-top, the user may be prompted to indicate whether he/she would like to view the television program with or without the associated interactive content (Step 155). If the user selects not to view the program with the interactive content, the program is played without the associated interactive content (Step 158).

If, however, the user selects to view the program with the interactive content (Step 155), the interactive data associated with the program is transferred from the memory of the interactive set-top to the memory of the webpad (Step 156) over the wireless connection.

The interactive content may include time stamps, triggers, or flags (hereinafter collectively “triggers”) that, when encountered during replay of the recorded program, cause the system to provide an interactive feature, such as soliciting a user response, providing a link to additional information, etc. Once a trigger is encountered, the interactive element may be displayed on the associated TV display (115, FIGS. 1 & 2) or may be transmitted from the interactive set-top to the webpad for display. The triggers may also be added to synchronize associated audio and video signals that are part of the interactive content of a program. Again, these triggers specify certain actions to be taken at precise moments in the broadcast to create the desired interactivity, i.e. displaying a web link, displaying an icon, posing a question to the user, etc.

The operation of the interactive system continues when the user views the program along with the interactive content (Step 157). The television program is preferably displayed on the television display while the interactive content is displayed on the webpad and/or interactive set-top. The webpad (201, FIG. 2) employs various application programs for processing the various types of signals, communications protocols, and instructions that may be sent or received. Frequently incoming signals will be displayed in a hypertext markup language (HTML) format. HTML is the set of markup symbols or codes inserted in a file intended for display on an Internet browser. Application programs for running HTML allow the user to receive interactive content on the webpad for a program as if it were a web page with links and other interactive functionality.

Once the interactive instructions are sent to the webpad, the video driver (109 FIG. 1) of the webpad (201, FIG. 2) takes the general instructions received by the internal processor (108a, FIG. 1) and converts them to messages and signals that can be readily used in the GUI (113, FIG. 1) and later displayed on the touch screen display (107, FIG. 1).

Similarly, a touch screen driver (111, FIG. 1) may convert the instructions received from the processor (108a, FIG. 1) into information that may be used by the touch screen display (110, FIG. 1) to properly display and read information input by the user. As the user selects or touches any of the GUI elements previously mentioned, the touch screen display reads the user input and interfaces with the touch screen driver to insure that the users input is processed by the webpad (201, FIG. 1) thereby completing the interactive process.

Moreover, the application permitting the viewer to add interactive content may include firmware, which when executed, denies the user the ability to ‘fast forward’ over the commercials that were recorded by the PVR along with the desired program. Once the desired program has been recorded, the interactive television program may be played back with or without interactive content as many times as desired.

Alternative Embodiment

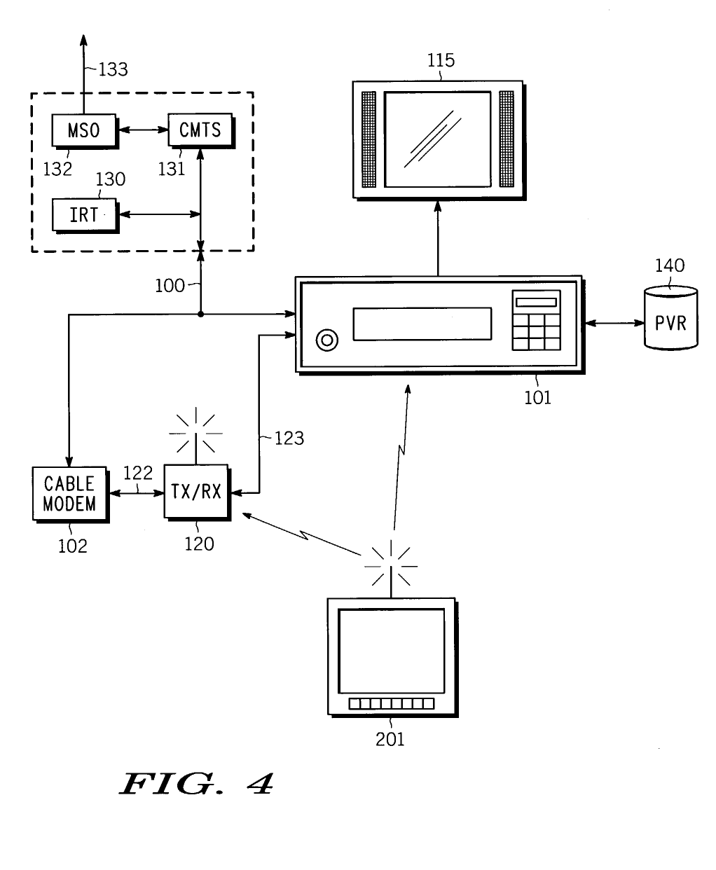

FIG. 4 is an illustration of an alternative embodiment of the interactive set-top recorder and playback system being described herein. A redundant explanation of those elements included in FIG. 2 will be omitted in describing FIG. 4. The cable modem (102) or other means of two-way communication of FIG. 4 is presented as an external component of the interactive set-top (101). By making the cable modem (102) an external component, the user is able to interface a service-specific cable modem (102) with the interactive set-top (101).

The cable modem (102) of FIG. 4 is also preferably connected to an external wireless transmitter/receiver (120) through an Ethernet or other connection (122). The external wireless transmitter/receiver (120) is subsequently connected to the interactive set-top (101) through a serial or other connection (123). The wireless transmitter/receiver (120) allows data received through the cable connection (100) to be sent directly to the webpad (201) as well as to the interactive set-top (101). According to this alternative embodiment, interactive information associated with the recorded program can be downloaded directly to the memory of the webpad (201) for use in viewing and interacting with the recorded interactive television program.

FIG. 4 also illustrates the interactive set-top box (101) interfacing with an external PVR (140). With an external PVR (140), a VCR, a DVD or other optical disc drive, a magneto-optical drive, a hard drive, or other similar recording equipment can be connected to the interactive set-top (101) to perform the function of recording data including, a television program and any interactive content that may be associated with that program. When a selected program is received by the interactive set-top (101), the program is transferred to the external PVR (140) for storage. Similarly, the external PVR (140) is also accessed during playback, interactive or otherwise, of the recorded programming.

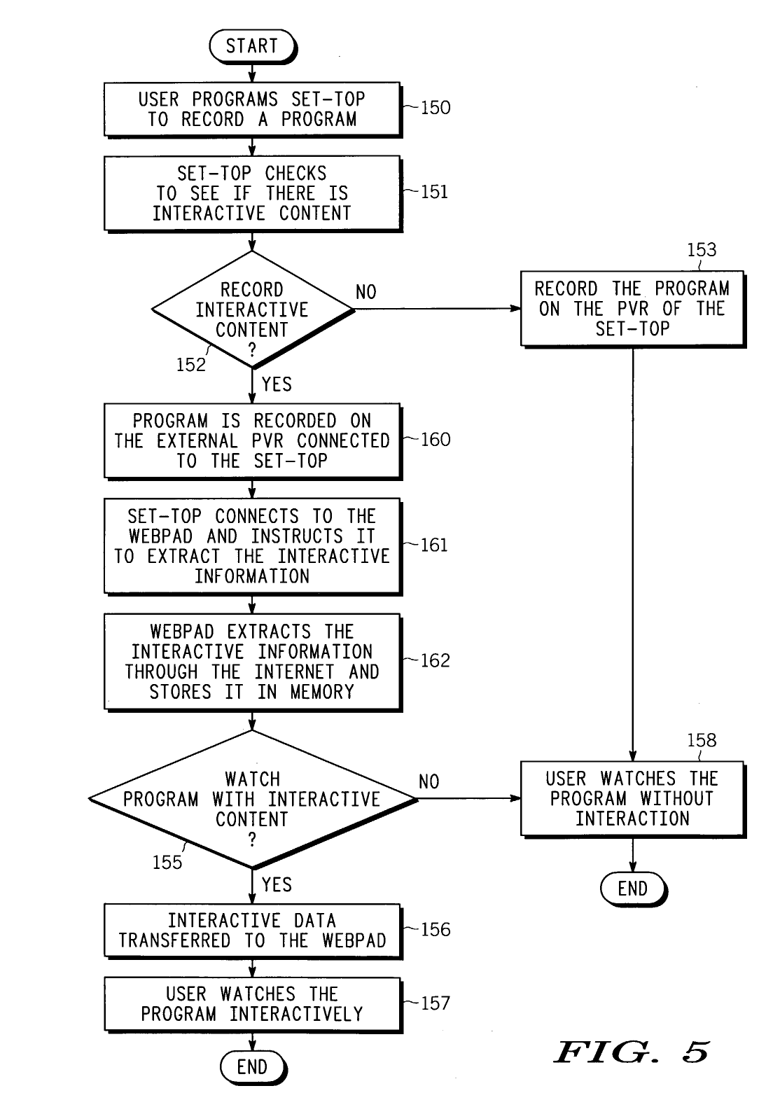

FIG. 5 illustrates a method of operating the alternative embodiment presented in FIG. 4. The operation of the system in FIG. 4 is similar to that of the system described with reference to FIG. 3, up to the point where the user selects to record a program with interactive content (Step 152). Consequently, a redundant explanation of those steps will be omitted.

When selected for recording, the interactive program is recorded on the PVR (140, FIG. 4) that is externally connected to the interactive set-top (Step 160). The interactive set-top then connects to the webpad and instructs the webpad to extract the interactive information (Step 161) associated with the selected program from the Internet. This command is given through the wireless communications link previously described. In response to the given command, the webpad extracts the interactive information through the Internet and stores that information in the webpad's local memory (Step 162).

The webpad of FIG. 4 communicates directly with the external cable modem through the wireless/transmitter receiver (120, FIG. 4) in downloading and storing the interactive portion of the television program. Once the user is asked whether to view the program interactively or not (Step 155), the process continues as previously described above.

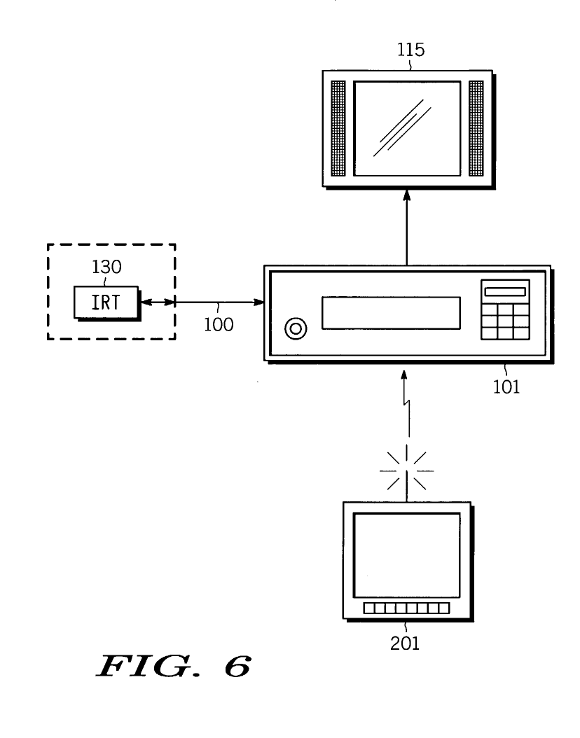

Not all interactive TV programming includes a supporting server located on the Internet or other network. In some instances, data that can be used to make the program interactive is included in the TV programming signal itself. FIG. 6 is an illustration of the interactive set-top recorder and playback system according to an embodiment that does not include access to the Internet. For example, the cable connection (100) of FIG. 6 interfaces independently with the IRT (130) in receiving a standard CATV signal. If the CATV signal is a radio frequency (RF) television signal, digital data may not sent with the RF television signal over the cable connection (100). Rather, data supporting and providing the interactive content of the TV programming may be encoded in the CATV signal, such as in the closed captioning portion of the signal.

According to the implementation illustrated in FIG. 6, the PVR of the interactive set-top (101) or other memory connected to the interactive set-top or webpad may be programmed with a list of interactive television programs. When the user selects a television program to record, the system compares the selected program with the list of common interactive television programs. If the program being recorded is included in the list of interactive television programs, the interactive set-top or webpad prepares to extract and collect the interactive information or content from the television program signal. In this manner, the system is able to prepare to extract and record the interactive content without the use of an Internet connection and Internet service provider (ISP) as previously described.

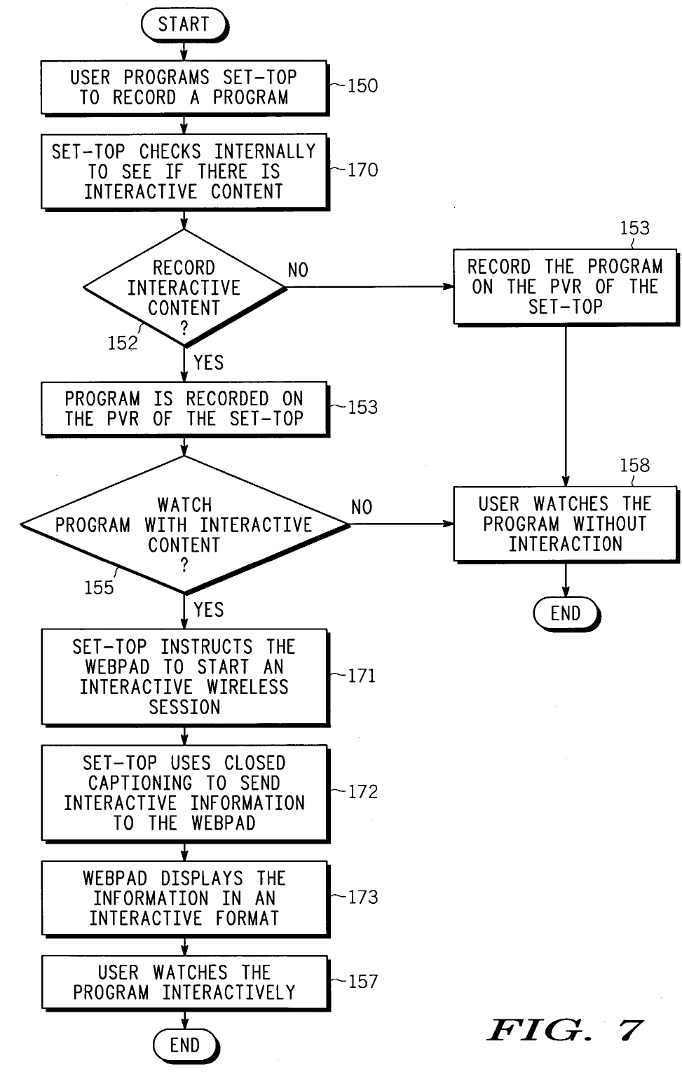

FIG. 7 is a flowchart illustrating a method of operating the system illustrated in FIG. 6 in accordance with the alternative embodiment. The process begins as the user programs the interactive set-top to record a program (Step 150). The interactive set-top then checks internally stored lists to determine if there is interactive content available (Step 170). Preferably, the check is performed by comparing the requested program with a set of known interactive program titles stored locally on the interactive set-top PVR or other memory.

The user is subsequently prompted to record the selected program with or without interactive content (Step 152). If the user elects to record the program without interactive content, only the program is recorded (Step 153). If the user selects to record the program with the interactive content, the program is similarly recorded on the PVR of the interactive set-top (Step 153). This recording includes extracting the interactive features or content from the program signal and storing the extracted data for use during playback of the recorded program.

When the user later initiates playback of the television program with interactive content (Step 155), the interactive set-top will retrieve the recorded interactivity data and features of the program from the PVR. The interactive set-top will then make use of that data to render the program interactive in the same manner as would have been done at the time the interactive program was originally received containing the interactive content.

In some embodiments, the interactive features of the program are displayed on the webpad. In such a case, the set-top instructs the webpad to initiate an interactive wireless session (Step 171). The interactive wireless session allows information relating to the interactive portion of the selected program to be passed between the interactive set-top and the webpad.

Once the interactive wireless session is initiated, the interactive set-top may use closed captioning capabilities of the program to send interactive information to the webpad (Step 172). This step is performed by the interactive set-top finding interactive content through searching for predetermined keywords or phrases in the closed caption content. The predetermined keywords will vary from program to program and may be stored in the local memory of the set top. These keywords are then used to duplicate the interactive content created by television program developers. The interactive information can be stripped out of the closed caption content by the interactive set-top box and transmitted in data packets to the webpad.

Once the transmitted information is received from the interactive set-top, the webpad will display the information in an interactive format (Step 173). Preferably, the webpad will populate a hypertext message (HTM) look and feel for the data displayed on the webpad for the user as the television program is viewed interactively (Step 157). This method allows the user to view the program interactively without having an Internet connection.

In conclusion, the present invention, in its various embodiments, allows for a recorded program to include interactive content when replayed at a later time. Specifically, the present invention allows a user to download or extract interactive content related to a program to a local memory device so that the interactive material can be presented to the user at a later time. The present invention also provides the content providers a way to prevent users from ‘fast forwarding’ over revenue generating commercials.

The preceding description has been presented only to illustrate and describe the embodiments of the invention. It is not intended to be exhaustive or to limit the invention to any precise form disclosed. Many modifications and variations are possible in light of the above teaching. It is intended that the scope of the invention be defined by the following claims.

What is claimed is:

1. A method for recording a television program with interactive content comprising recording data supporting interactive features of said television program in addition to recording said television program.

2. The method of claim 1, further comprising:
determining whether the television program includes interactive content; and,
if the television program includes interactive content, selectively recording said data supporting the interactive features of said television program.

3. The method of claim 2, wherein determining whether the television program includes interactive content comprises comparing the television program with a list of interactive television programs to determine whether the television program includes interactive content.

4. The method of claim 3, further comprising:
accessing a network; and
retrieving said list of interactive television programs.

5. The method of claim 4, wherein the network comprises the Internet.

6. The method of claim 1, wherein recording the television program and the data supporting interactive features of the television program comprises:
receiving the television program in an interactive set-top;
extracting said data supporting interactive features of the television program; and
recording the television program and the data supporting interactive features of the television program in a memory device communicatively connected to the interactive set-top.

7. The method of claim 1, wherein recording the television program and the data supporting interactive features of the television program comprises downloading said data from a computer network.

8. The method of claim 7, wherein downloading said data from a computer network further comprises downloading said data from the Internet.

9. The method of claim 1, wherein recording data supporting interactive features of said television program in addition to recording said television program further comprises recording said data and said television program in a personal video recorder (PVR).

10. The method of claim 9, wherein the PVR comprises an optical disc drive.

11. The method of claim 9, wherein the PVR comprises a videocassette recorder.

12. The method of claim 9, wherein the PVR comprises a hard drive.

13. The method of claim 1, further comprising:
retrieving said television program and said data supporting said interactive features of said television program from a storage device; and
playing said television program including providing said interactive features.

14. The method of claim 13, wherein said providing said interactive features comprises transmitting said data supporting said interactive features to a remote control unit.

15. The method of claim 14, further comprising sending user feedback from the remote control unit.

16. The method of claim 14, wherein said transmitting said data to a remote control unit is performed wirelessly.

17. The method of claim 7, wherein said downloading said data is performed by a remote control unit in communication with said computer network.

18. The method of claim 17, wherein said remote control unit is a webpad in communication with the Internet.

19. The method of claim 13, further comprising prohibiting fast forwarding through commercials during said playing of said television program.

20. A system for recording a television program with interactive content, the system comprising:
an interactive set-top including a processor; and
an input for receiving a television signal in said set-top;
wherein the processor of the interactive set-top is programmed to determine whether a user-selected television program has associated interactive content, and, if the television program has associated interactive content, record the television program and the interactive content.

21. The system of claim 20, further comprising a television display connected to said set-top for displaying said television program.

22. The system of claim 20, further comprising a remote control unit that communicates wirelessly with said set-top to provide interactive features of said television program based on said interactive content.

23. The system of claim 22, wherein said remote control unit is a webpad.

24. The system of claim 20, wherein the interactive set top further comprises a network connection.

25. The system of claim 24, wherein the processor of the interactive set-top is further programmed to:
access a network through the network connection;
retrieve a list of programs that typically include interactive content from the network; and
compare the television program with the list of typically interactive programs to determine whether the program includes interactive content.

26. The system of claim 20, wherein the processor of the interactive set-top is further programmed to:
receive a television signal carrying the television program through the input;
extract data for the interactive content of the television program from the television signal; and
record the television program and the data for the interactive content of the television program in a storage device.

27. The system of claim 24, wherein the processor of the interactive set-top is further programmed to:
access a network through the network connection;
download data for the interactive content of the television program from the network; and
record the television program and the data for the interactive content of the television program in a storage device.

28. The system of claim 20, wherein a storage device is integrated into the set-top.

29. The system of claim 20, wherein a storage device is external to, and connected to, the set-top box.

30. The system of claim 20, further comprising an optical disk drive for storing the television program and interactive content.

31. The system of claim 30, wherein the storage device comprises a digital video disc (DVD) writer.

32. The system of claim 20, further comprising a hard drive for storing the television program and interactive content.

33. The system of claim 20, further comprising a videocassette recorder for storing the television program and interactive content.

34. A system for recording a television program with interactive content comprising:
means for identifying data supporting interactive features of said television program; and
means for recording said data supporting interactive features of said television program in addition to recording said television program.

35. The system of claim 34, further comprising:
means for determining whether the television program includes interactive content; and,
if the television program includes interactive content, means for selectively recording said data supporting the interactive features of said television program.

36. The system of claim 25, wherein said means for determining whether the television program includes interactive content comprise means for comparing the television program with a list of interactive television programs to determine whether the television program includes interactive content.

37. The system of claim 36, further comprising:
means for accessing a network; and
means for retrieving said list of interactive television programs from said network.

38. The system of claim 37, wherein said network comprises the Internet.

39. The system of claim 34, wherein said means for recording the television program and the data supporting interactive features of the television program comprise:
means for receiving the television program in an interactive set-top;
means for extracting said data supporting interactive features of the television program; and
means for recording the television program and the data supporting interactive features of the television program in a memory device communicatively connected to the interactive set-top.

40. The system of claim 34, wherein said means for recording the television program and the data supporting interactive features of the television program comprise means for downloading said data from a computer network.

41. The system of claim 40, wherein said computer network comprises the Internet.

42. The system of claim 34, further comprising:
means for retrieving said television program and said data supporting said interactive features of said television program from a storage device; and
means for playing said television program including means for providing said interactive features.

43. The system of claim 42, wherein said means for providing said interactive features comprise means for transmitting said data supporting said interactive features to a remote control unit.

44. The system of claim 43, further comprising means for sending user feedback from the remote control unit.

45. The system of claim 34, further comprising means for preventing fast forwarding through commercials during said playing of said television program.
